(19) United States
(12) Patent Application Publication
(10) Pub. No.: US 2026/0329802 A1
(43) Pub. Date: Oct. 22, 2026

(54) DATA TRANSMISSION DEVICE AND METHOD

(71) Applicant: Nuvoton Technology Corporation, Hsinchu Science Park (TW)

(72) Inventors: Chung-Chi WANG, Hsinchu Science Park (TW); Ching-I TSENG, Hsinchu Science Park (TW)

(21) Appl. No.: 19/645,661

(22) Filed: Apr. 13, 2026

(30) Foreign Application Priority Data
Apr. 17, 2025 (TW) 114114571

(51) Int. Cl. G06F 13/42

(52) U.S. Cl. CPC G06F 13/4282; G06F 2213/0002

(57) ABSTRACT

A data transmission device for transmitting data to a plurality of target devices in Octal Mode is provided. A data buffer is configured to store data. Data bit conversion modules are coupled to the data buffer and are configured to receive data from the data buffer and copy or reassemble a plurality of bits of data to generate new data items. A byte reordering module is coupled to the data bit conversion module and is configured to receive new data items and perform a reordering on bit order or byte order of new data items and output reordered data items. In addition, a serial peripheral interface transmission module is coupled to the byte reordering module and is configured to transmit reordered data items to the plurality of target devices in Octal Mode after reordering.

### CROSS REFERENCE TO RELATED APPLICATIONS

This application claims priority of Taiwan patent application No. 114114571, filed Apr. 17, 2025, the entirety of which is incorporated by reference herein.

### TECHNICAL FIELD

The present disclosure relates to a data transmission device and method of Serial Peripheral Interface (SPI), and, in particular, it relates to a data transmission device and a method for data synchronization and multiplex transmission mode applied to an Octal Serial Peripheral Interface (Octal SPI).

### BACKGROUND

A Serial Peripheral Interface (SPI) is a synchronous serial communication protocol that is widely used in digital circuits, such as microcontrollers, memory, and sensors.

Conventional SPI interfaces typically use four lines for communication: clock (CLK), Master Out Slave In (MOSI), Master In Slave Out (MISO), and Chip Select (CS). To increase the data transmission rate, Octal Serial Peripheral Interface (Octal SPI) technology can be used, which uses eight data lines for parallel data transmission.

However, conventional SPI interfaces usually only achieve one-to-one communication within the same data cycle (i.e., data transmission from a master to a slave). For example, in Quad Mode, a master in Quad Mode can only communicate with a slave in Quad Mode.

This one-to-one communication limits the overall data throughput of the system, especially in applications where simultaneous data exchange with multiple slaves is required, such as communication with multiple memory devices or applications that need to transmit the same data to multiple devices.

In addition, the security of data is also an important consideration during data transmission. Conventional data transmission methods usually transmit data directly through the SPI interface, and if data is not encrypted, it is easy to be eavesdropped upon or tampered with, which has potential security risks.

In addition, in some application scenarios, it is necessary to disassemble a data item into multiple sub-data and send them to different devices. The conventional practice for this requires the completion of multiple data cycles, which affects the transmission efficiency of data.

As mentioned above, there are technical issues that need to be solved in the existing SPI technology in terms of simultaneous transmission of multiple devices in the same data cycle, data security, and transmission efficiency.

### BRIEF SUMMARY

In one of the embodiments, a data transmission device for transmitting data to a plurality of target devices in Octal Mode is provided. A data buffer is configured to store at least one data. At least one data bit conversion module is coupled to the data buffer and is configured to receive at least one data from the data buffer and copy or reassemble a plurality of bits of at least one data to generate at least one new data item. A byte reordering module is coupled to the data bit conversion module and is configured to receive at least one new data item and perform a reordering on bit order or byte order of at least one new data item and output at least one reordered data item. In addition, a serial peripheral interface transmission module is coupled to the byte reordering module and is configured to transmit at least one reordered data item to the target devices in Octal Mode after the reordering.

According to the data transmission device in this disclosure, through the cooperation of data buffer, data bit conversion module, byte reordering module, serial peripheral interface (SPI) transmission module and target devices, the limitation that the conventional SPI can only communicate with a single device in the same data cycle is addressed, and the synchronous or interleaved data transmission of multiple devices in Octal SPI mode is implemented, the complexity, efficiency and security of data transmission are improved, and it can be applied in fields such as data backup, distributed data storage to enhance storage efficiency and space.

### BRIEF DESCRIPTION OF THE DRAWINGS

FIG. 1 is a schematic diagram of an embodiment of the data transmission device in this disclosure;

FIG. 2 is a schematic diagram of the signal waveform of the data transmission device in an embodiment in this disclosure;

FIG. 3 is a schematic diagram of another embodiment of the data transmission device in this disclosure; and

FIG. 4 is a schematic diagram of the signal waveform of another embodiment of the data transmission device in this disclosure.

### DETAILED DESCRIPTION

The following describes embodiments of the present disclosure through specific exemplary implementations. Those skilled in the art will understand other advantages and effects of the present disclosure based on the contents in this disclosure, and may likewise implement or apply the disclosure using various alternative but equivalent embodiments.

In one of the embodiments, the term “at least one” as used in the present disclosure refers to one or more (e.g., one, two, or three or more), “a plurality of” refers to two or more (e.g., two, three, four, or ten or more), and “electrically connected” refers to being electrically linked or coupled. However, the present disclosure is not limited to the examples described in the embodiments.

The present disclosure is described with reference to the accompanying drawings, in which like reference numerals throughout the drawings denote similar or identical elements. The drawings are not drawn to scale and are provided merely for illustrative purposes to facilitate understanding of the disclosure. Various embodiments of the invention are described below as illustrative examples. This means that many specific details, relationships, and methods are disclosed to provide a thorough understanding of the invention. Nevertheless, one skilled in the art will recognize that the invention may be practiced without one or more of these specific details, or by using other methods.

For example, well-known structures or operations are not described in detail to avoid unnecessarily obscuring the invention. The present disclosure is not limited to the sequence of acts or events described, as some acts may occur in a different order or concurrently with other acts or events. Furthermore, not all illustrated acts or events are required to be performed in the method of the present invention.

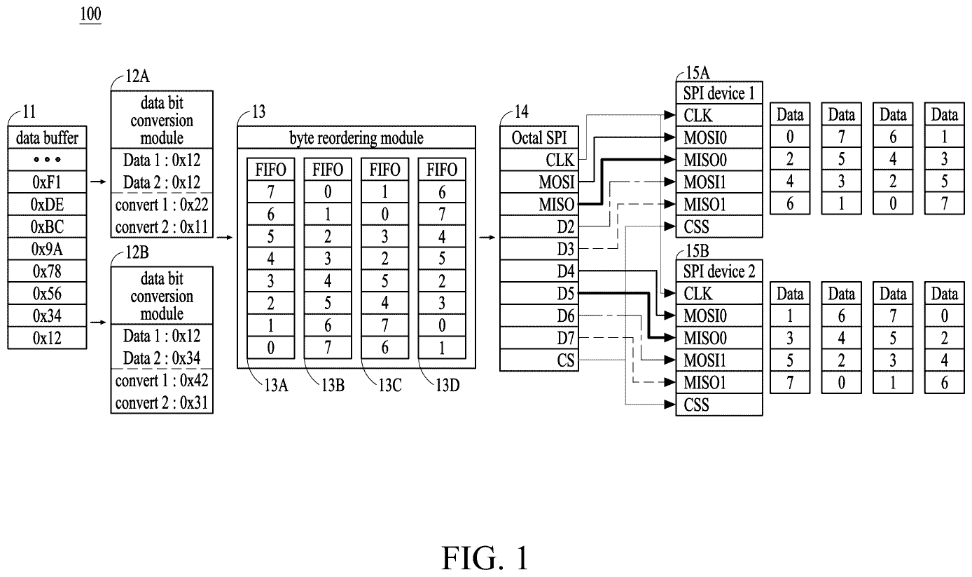

FIG. 1 is a schematic diagram of an embodiment of the data transmission device in this disclosure.

Please refer to FIG. 1, which is a schematic diagram of an embodiment of the data transmission device 100 in this disclosure. The data transmission device 100 in this disclosure is applicable to the Octal SPI communication protocol, and in one of the embodiments, its main function is to transmit data to multiple target devices in a synchronous or interleaved manner within a data cycle, such as two Quad Mode devices 15A, 15B, or multiple devices of other modes, but is not limited to.

As shown in FIG. 1, the data transmission device 100 mainly includes: data buffer 11, at least one data bit conversion module 12A, 12B, byte reordering module 13, Octal Serial Peripheral Interface (SPI) transmission module 14 and target device 15A, 15B.

A data buffer 11 is used for storing at least one of raw data item. As shown in FIG. 1, in an embodiment, the data buffer 11 may include a plurality of registers to store a plurality of data items, for example, 0×F1, 0×0E, 0×BC, 0×78, 0×56, 0×34, 0×12, but is not limited to.

In one of the embodiments, the data buffer 11 can receive a raw data item and copy it into a plurality of data items that are identical. In another embodiment, the data buffer 11 can directly receive and store a plurality of different raw data items, but is not limited to.

Data bit conversion modules 12A, 12B are coupled to data buffer 11. In this embodiment, the data transmission device 100 includes two data bit conversion modules 12A and 12B, but this disclosure is not limited to, and the number of data bit conversion modules can be adjusted according to the number of target devices and the transmission mode. The data bit conversion modules 12A and 12B receive data from the data buffer 11, and according to the preset rule or the dynamically set rule, the bits of data are reassembled to generate new data.

In the embodiment shown in FIG. 1, for example, data is transmitted to two target devices 15A and 15B, and the target devices 15A and 15B both adopt a Quad mode.

In one of the embodiments, the data bit conversion module 12A receives two data items, for example, both are 0×12 (binary representation is 00010010), the data bit conversion module 12A can select the lower four bits (i.e., 0×2, binary representation is 0010) of the first data item 0×12 and the lower four bits (i.e., 0×2, binary representation is 0010) of the second data item 0×12 to assemble the first new data item 0×22 (binary representation is 00100010), but is not limited to. In one of the embodiments, the data bit conversion module 12A can select the higher four bits (i.e., 0×1, binary representation is 0001) of the first data item 0×12 and the higher four bits (i.e., 0×1, binary representation is 0001) of the second data item 0×12 to assemble the second new data item 0×11 (binary representation is 00010001), but is not limited to.

In one of the embodiments, the data bit conversion module 12B receives two data items, such as 0×12 (binary representation is 00010010) and 0×34 (binary representation is 00110100), and the data bit conversion module 12B can select the lower four bits (i.e., 0×2, binary representation is 0010) of the first data item 0×12 and the lower four bits (i.e., 0×4, binary representation is 0100) of the second data item 0×34 to assemble the first new data item 0×42 (binary representation is 01000010), but is not limited to. The data bit conversion module 12B can select the higher bits of the first data item 0×12 (i.e., 0×1, binary representation is 0001) and the higher bits of the second data item 0×34 (i.e., 0×3, binary representation is 0011) to assemble the second new data item 0×31 (binary representation is 00110001), but is not limited to.

In another embodiment (described in more detail later), for example, if data is to b transmitted to more (e.g., four) Dual Mode devices, the data bit conversion module may receive more (e.g., four) data items, and selects two bits from each of them to assemble more (e.g., four) new data items, but is not limited to. In one of the embodiments, the selection of bits may be arbitrary, but the positions of the bits selected in each data shall correspond to the same, but is not limited to.

In one of the embodiments, the byte reordering module 13 is coupled to the output terminal of the data bit conversion modules 12A and 12B, and receives the new data generated by the data bit conversion modules 12A and 12B.

In one of the embodiments, the byte reordering module 13 includes four first in first out (FIFO) reassembly data buffers 13A, 13B, 13C, and 13D. In the embodiment shown in FIG. 1, the reassembly data buffers 13A, 13B, 13C, and 13D are implemented in four FIFOs, but is not limited to. The byte reordering module receives new data generated from the data bit conversion modules 12A and 12B, and reorders the byte order or bit order of these new data to increase the complexity of data arrangement, but is not limited to.

In one of the embodiments, the Octal serial peripheral interface transmission module 14 is coupled to the output terminal of the byte reordering module 13, but is not limited to. In one of the embodiments, the serial peripheral interface transmission module 14 receives reordered data from the byte reordering module 13 and transmits the data simultaneously to a plurality of target devices, such as two devices operating in Quad Mode including a first target devices 15A (marked SPI device 1 in FIG. 1) and a second target device 15B (marked SPI device 2 in FIG. 1), in one data cycle.

As shown in FIG. 1, the serial peripheral interface transmission module 14 includes a clock signal terminal CLK, a chip select terminal CS and eight data output terminals MOSI, MISO, D2-D7, and can simultaneously transmit signals to the first target device 15A and the second target device 15B.

In one of the embodiments, the clock signal terminal CLK of the serial peripheral interface transmission module 14 is electrically coupled to the clock signal terminal CLK of the first target device 15A and the second target device 15B; the first data output terminal MOSI of the serial peripheral interface transmission module 14 is electrically coupled to the first data receiving terminal MOSI0 of the first target device 15A; the second data output terminal MISO of the serial peripheral interface transmission module 14 is electrically coupled to the second data receiving terminal MISO0 of the first target device 15A; the third data output terminal D2 of the serial peripheral interface transmission module 14 is electrically coupled to the third data receiving terminal MOSI1 of the first target device 15A; the fourth data output terminal D3 of the serial peripheral interface transmission module 14 is electrically coupled to the fourth data receiving terminal MISO1 of the first target device 15A; the fifth data output terminal D4 of the serial peripheral interface transmission module 14 is electrically coupled to the first data receiving terminal MOSI0 of the second target device 15B; the sixth data output terminal D5 of the serial peripheral interface transmission module 14 is electrically coupled to the second data receiving terminal MISO0 of the second target device 15B; the seventh data output terminal D6 of the serial peripheral interface transmission module 14 is electrically coupled to the third data receiving terminal MOSI1 of the second target device 15B; the eighth data output terminal D7 of the serial peripheral interface transmission module 14 is electrically coupled to the fourth data receiving terminal MISO1 of the second target device 15B; The chip select terminal CS of the serial peripheral interface transmission module 14 is electrically coupled to the chip selected terminal CSS of the first target device 15A and the second target device 15B, but is not limited to.

In one of the embodiments, the first target device 15A receives four reordered data items from the byte reordering module 13, such as 0246, 7531, 6420, 1357, respectively, but is not limited to. In one of the embodiments, the second target device 15B receives four reordered data items from the byte reordering module 13, such as 1357, 6420, 7531, 0246, respectively, but is not limited to.

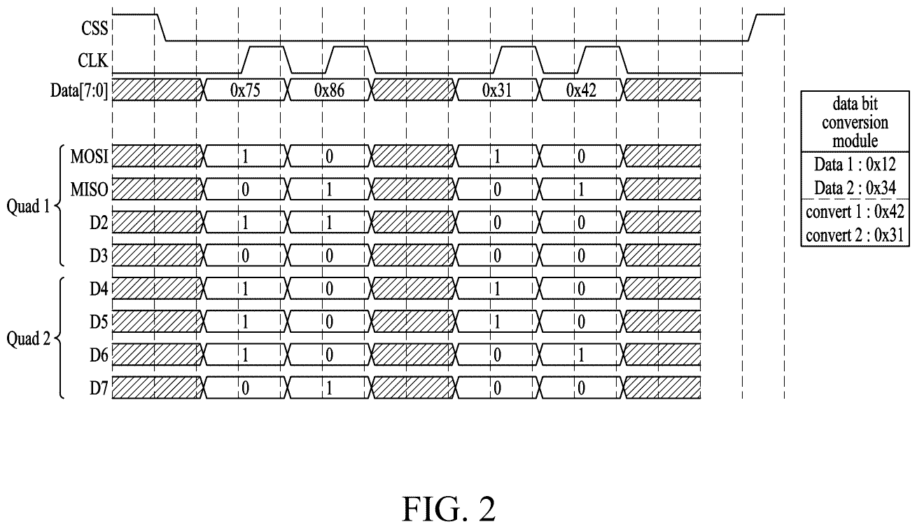

FIG. 2 is a schematic diagram of the signal waveform of data transmitted to two Quad Mode devices in an embodiment of the data transmission device 100 in this disclosure.

With FIG. 1, it can be seen from FIG. 2 that the data buffer 11 outputs two data Data1=0×12 and Data2=0×34 to the data bit conversion module 12A or the data bit conversion module 12B, but is not limited to.

In one of the embodiments, after the processing by a data bit conversion module 12A and a data bit conversion module 12B, Data1=0×12 and Data2=0×34 are converted into 0×42 (convert1) and 0×31 (convert2), respectively.

Then, the data 0×42, 0×31, 0×86, 0×75 of data signal Data [7:0] sequentially pass through the byte reordering module 13 and the serial peripheral interface transmission module 14, and are transmitted to the first target device 15A (Quad 1) through the first data output terminal MOSI to the fourth data output terminal D3 of the peripheral interface transmission module 14, and are transmitted to the second target device 15B (Quad 2) through the fifth data output terminal D4 to the eighth data output terminal D7 of the serial peripheral interface transmission module 14, but is not limited to.

In one of the embodiments, as shown in FIG. 2, at the rising edge of the first clock cycle, the serial peripheral interface transmission module 14 transmits the lower 4 bits of the data 0×42 (i.e., 0×2, binary is 0010) to the first target device 15A through the first data output terminal MOSI to the fourth data output terminal D3, and transmits the higher 4 bits of the data 0×42 (i.e., 0×4, binary 0100) to the second target device 15B through the fifth data output terminal D4 to the eighth data output terminal D7, but is not limited to.

In one of the embodiments, as shown in FIG. 2, at the rising edge of the second clock cycle, the serial peripheral interface transmission module 14 transmits the lower 4 bits (i.e., 0×1, binary 0001) of the data 0×31 to the first target device 15A through the first data output terminal MOSI, the second data output terminal MISO, the third data output terminal D2, the fourth data output terminal D3, and transmits the upper 4 bits (i.e., 0×3, binary 0011) of the data 0×31 to the second target device 15B through the fifth data output terminal D4, the sixth data output terminal D5, the seventh data output terminal D6, the eighth data output terminal D7, but is not limited to.

In one of the embodiments, if there is a subsequent converted data (e.g., 0×86), then at the rising edge of the third clock cycle, the serial peripheral interface transmission module 14 transmits the lower 4 bits (i.e., 0×6, binary is 0110) of the data 0×86 to the first target device 15A through the first data output terminal MOSI, the second data output terminal MISO, the third data output terminal D2, the fourth data output terminal D3, and transmits the higher 4 bits (i.e., 0×8, binary is 1000) of the data 0×86 to the second target device 15B through the fifth data output terminal D4, the sixth data output terminal D5, the seventh data output terminal D6, the eighth data output terminal D7, but is not limited to.

In one of the embodiments, if there is a subsequent converted data (e.g., 0×75), then at the rising edge of the fourth clock cycle, the serial peripheral interface transmission module 14 transmits the lower 4 bits (i.e., 0×5, binary is 0101) of the data 0×75 to the first target device 15A through the first data output terminal MOSI, the second data output terminal MISO, the third data output terminal D2, the fourth data output terminal D3, and transmits the higher 4 bits (i.e., 0×7, binary is 0111) of the data 0×75 to the second target device 15B through the fifth data output terminal D4, the sixth data output terminal D5, the seventh data output terminal D6, the eighth data output terminal D7, but is not limited to.

By analogy, in this way, the disclosure may synchronize and transmit data to two Quad Mode devices, respectively.

As mentioned above, in the embodiment of FIG. 2, the first target device 15A and the second target device 15B receive the reordered data from the byte reordering module 13, respectively. For example, the first target device 15A may receive data 2, 1, 6, and 5 sequentially, and the second target device 15B may receive data 4, 3, 8, and 7 sequentially, but is not limited to.

Through the above-mentioned data bit conversion and byte/bit reordering, the data transmission device in this disclosure can simultaneously transmit the data with a specific arrangement and assembly to multiple target devices in one data cycle, the synchronization or interleaved transmission of data has been implemented.

In addition, since the data is reassembled and reordered before the transmission, its complexity increases and it is less likely to be cracked, so the data transmission device in this disclosure is also suitable for applications that require high data security, such as data backup or distributed data storage. By decentralizing data to different devices, the performance and space utilization of the storage system can be improved.

Through the cooperation of data buffer, data bit conversion module, byte reordering module, serial peripheral interface transmission module and target device, the data transmission device in this disclosure solves the limitation that the conventional SPI can only communicate with a single device in the same data cycle, realizes the synchronous or interleaved data transmission of multiple devices in Octal SPI mode, also improves the complexity, efficiency and security of data transmission, and can be applied to fields such as data backup, distributed data storage to enhance the performance and space of storage.

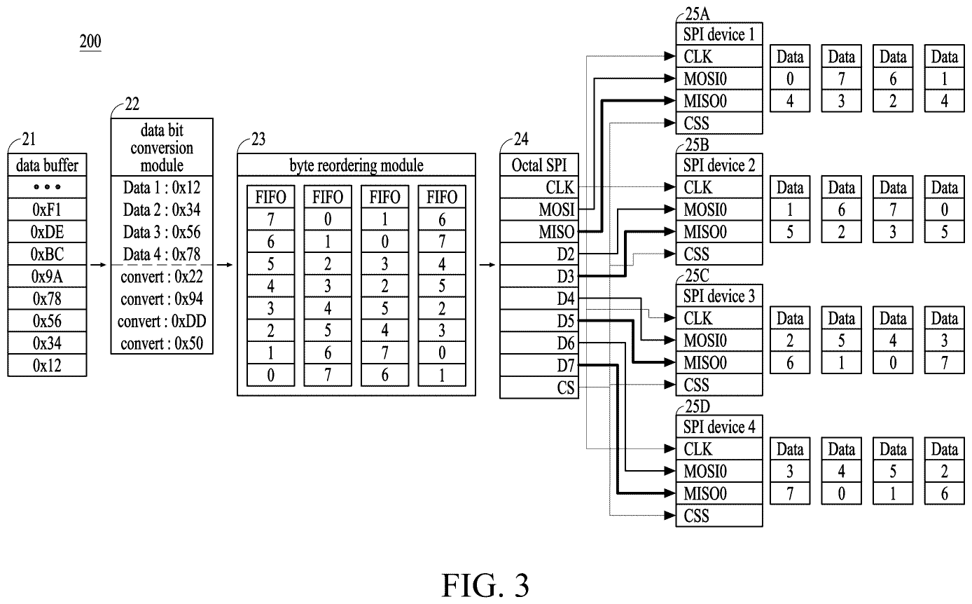

FIG. 3 is a schematic diagram of another embodiment of the data transmission device 200 in this disclosure.

The data transmission device 200 in this disclosure is similar to the data transmission device 100 in FIG. 1 and is also applicable to the Octal SPI communication protocol. In the embodiment shown in FIG. 3, the main function of the data transmission device 200 is to transmit data to multiple target devices, such as four Dual Mode target devices 25A, 25B, 25C, 25D (marked as SPI device 1, SPI device 2, SPI device 3, SPI device 4 respectively in FIG. 3), but is not limited to, and can also be multiple devices in other modes.

As shown in FIG. 3, the data transmission device 200 mainly includes: data buffer 21, data bit conversion module 22, byte reordering module 23, octal serial peripheral interface (SPI) transmission module 24 and four target devices 25A, 25B, 25C, 25D, but is not limited to.

In one of the embodiments, a data buffer 21 is used for storing at least one raw data item. As shown in FIG. 3, the data buffer 21 may include a plurality of registers to store multiple data items, for example, 0×F1, 0×0E, 0×BC, 0×78, 0×56, 0×34, 0×12, but is not limited to.

In one of the embodiments, the data buffer 21 may receive one raw data item and copy or reassemble it to convert it into a plurality of data items that are identical, but is not limited to. In another embodiment, the data buffer 21 may also directly receive and store a plurality of different raw data items, but is not limited to.

In one of the embodiments, the data bit conversion module 22 is coupled to the data buffer 21. The data bit conversion module 22 receives data from the data buffer 21 and reassembles a plurality of bits of the data according to the preset rule or the dynamically set rule to generate new data.

In the embodiment shown in FIG. 3, the data bit conversion module 22 receives data from the data buffer 21. In one of the embodiments, the data bit conversion module 22 receives four data items, such as 0×12, 0×34, 0×56 and 0×78, and the data bit conversion module 22 can select the lower 2 bits of the first data item 0×12 (i.e., 0b10, which is 2 in decimal), the lower 2 bits of the second data item 0×34 (i.e., 0b00, which is 0 in decimal), the lower 2 bits of the third data 0×56 (i.e., 0b10, which is 2 in decimal) and the lower 2 bits of the fourth data 0×78 (i.e., 0b00, which is 0 in decimal) to assemble the first new data item 0×22 (0b00100010), but is not limited to.

In one of the embodiments, the data bit conversion module 22 sequentially selects the 3rd and 4th bits from the lower bits of the first data item 0×12, the 3rd and 4th bits from the lower bits of the second data item 0×34, the 3rd and 4th bits from the lower bits of the third data 0×56, the 3rd and 4th bits from the lower bits of the fourth data 0×78 to assemble the second new data item 0×94, but is not limited to. The data bit conversion module 22 sequentially selects the 5th and 6th bits from the lower bits of the first data item 0×12, the 5th and 6th bits from the lower bits of the second data item 0×34, the 5th and 6th bits from the lower bits of the third data 0×56, the 5th and 6th bits from the lower bits of the fourth data 0×78 to assemble the third new data item 0×DD, but is not limited to. The data bit conversion module 22 sequentially selects the 7th and 8th bits from the lower bits of the first data item 0×12 (or the 1st and 2nd bits from the higher bits), the 7th and 8th bits from the lower bits of the second data item 0×34, the 7th and 8th bits from the lower bits of the third data item 0×56, the 7th and 8th bits from the lower bits of the fourth data item 0×78 to assemble the fourth new data 0×50, but is not limited to.

In one of the embodiments, four new data items are generated in this way, for example: 0×22, 0×94, 0×DD, 0×50. It is worth noting that the above-mentioned data reorganization method is only an example, and this disclosure is not limited to, and the data bit conversion module 22 can adjust the selection rules and assembly methods of bits according to demand.

In one of the embodiments, the byte reordering module 23 is coupled to the output terminal of the data bit conversion module 22 and receives new data generated by the data bit conversion module 22. In this embodiment, the byte reordering module 23 includes, for example, four FIFO buffers to store new data produced by the data bit conversion module 22. In one of the embodiments, the byte reordering module 23 may also reorder the byte order or bit order of the data to increase the complexity of the data arrangement, but is not limited to.

In one of the embodiments, an octal serial peripheral interface (SPI) transmission module 24 is coupled to the output of a byte reordering module 23. The serial peripheral interface transmission module 24 receives data from the byte reordering module 23 and transmits data simultaneously to multiple target devices, such as four target devices 25A, 25B, 25C, 25D operating in Dual Mode using Octal SPI protocol, in one data cycle.

As shown in FIG. 3, the serial peripheral interface transmission module 24 includes a clock signal terminal CLK, a chip select terminal CS, and eight data output terminals: first data output terminal MOSI, second data output terminal MISO, third data output terminal D2, fourth data output terminal D3, fifth data output terminal D4, sixth data output terminal D5, seventh data output terminal D6, eighth data output terminal D7. In the embodiment shown in FIG. 3, for example, data is transmitted to four target devices 25A, 25B, 25C, and 25D, and the target devices 25A, 25B, 25C, and 25D are all Dual Mode devices, but is not limited to.

In one of the embodiments, the clock signal terminal CLK of the serial peripheral interface transmission module 24 is electrically coupled to the clock signal terminal CLK of the target devices 25A, 25B, 25C, and 25D, but is not limited to.

In one of the embodiments, the first data output terminal MOSI of the serial peripheral interface transmission module 24 is electrically coupled to the first data receiving terminal MOSI0 of the first target device 25A, but is not limited to. In one of the embodiments, the second data output terminal MISO of the serial peripheral interface transmission module 24 is electrically coupled to the second data receiving terminal MISO0 of the first target device 25A, but is not limited to.

In one of the embodiments, the third data output terminal D2 of the serial peripheral interface transmission module 24 is electrically coupled to the first data receiving terminal MOSI0 of the second target device 25B, but is not limited to. In one of the embodiments, the fourth data output terminal D3 of the serial peripheral interface transmission module 24 is electrically coupled to the second data receiving terminal MISO0 of the second target device 25B, but is not limited to.

In one of the embodiments, the fifth data output terminal D4 of the serial peripheral interface transmission module 24 is electrically coupled to the first data receiving terminal MOSI0 of the third target device 25C, but is not limited to. In one of the embodiments, the sixth data output terminal D5 of the serial peripheral interface transmission module 24 is electrically coupled to the second data receiving terminal MISO0 of the third target device 25C, but is not limited to.

In one of the embodiments, the seventh data output terminal D6 of the serial peripheral interface transmission module 24 is electrically coupled to the first data receiving terminal MOSI0 of the fourth target device 25D, but is not limited to. In one of the embodiments, the eighth data output terminal D7 of the serial peripheral interface transmission module 24 is electrically coupled to the second data receiving terminal MISO0 of the fourth target device 25D, but is not limited to.

In one of the embodiments, the chip select terminal CS of the serial peripheral interface transmission module 24 electrically coupled to the chip selected terminal CSS of the target device 25A, 25B, 25C, 25D, but is not limited to.

In one of the embodiments, the first target device 25A receives four reordered data items from the byte reordering module 23, such as 04, 73, 62, 14, respectively, but is not limited to.

In one of the embodiments, the second target device 25B receives four reordered data items from the byte reordering module 23, such as 15, 62, 73, 05, respectively, but is not limited to.

In one of the embodiments, the third target device 25C receives four reordered data items from the byte reordering module 23, such as 26, 51, 40, 37, respectively, but is not limited to.

In one of the embodiments, the fourth target device 25D receives four reordered data items from the byte reordering module 23, such as 37, 40, 51, 26, respectively, but is not limited to.

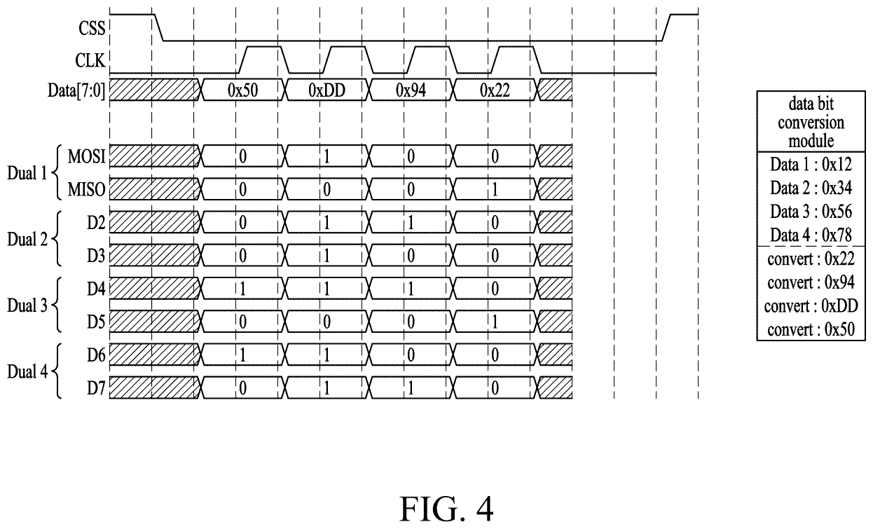

FIG. 4 is a schematic diagram of the signal waveform of data transmission to four Dual Mode devices in an embodiment of the data transmission device 200 in this disclosure.

With FIG. 3, it can be seen from FIG. 4 that the data buffer 21 outputs four data items Data1=0×12, Data2=0×34, Data3=0×56 and Data4=0×78 to the data bit conversion module 22, but is not limited to.

In one of the embodiments, after the processing by the data bit conversion module 22, Data1=0×12, Data2=0×34, Data3=0×56 and Data4=0×78 are converted into 0×22 (convert1), 0×94 (convert2), 0×DD (convert3), and 0×50 (convert4).

After that, data 0×22, 0×94, 0×DD, 0×50 sequentially pass through the byte reordering module 23 and the serial peripheral interface transmission module 24, and are transmitted to the first target device 25A (Dual 1) through the first data output terminal MOSI to the second data output terminal MISO of the serial peripheral interface transmission module 24; and are transmitted to the second target device 25B (Dual 2) through the third data output terminal D2 to the fourth data output terminal D3 of the serial peripheral interface transmission module 24; and are transmitted to the third target device 25C (Dual 3) through the fifth data output terminal D4 to the sixth data output terminal D5 of the serial peripheral interface transmission module 24; and are transmitted to the fourth target device 25D (Dual 4) through the seventh data output terminal D6 to the eighth data output terminal D7 of the serial peripheral interface transmission module 24, but is not limited to.

In one of the embodiments, as shown in FIG. 4, at the rising edge of the first clock cycle, the serial peripheral interface transmission module 24 transmits the 1st and 2nd bits from the lower bits of data 0×22 (i.e., 0×2, which is 10 in binary) to the first target device 25A through the first data output terminal MOSI and the second data output terminal MISO; the 3rd and 4th bits from the lower bits of data 0×22 (i.e., 0×0, which is 00 in binary) are transmitted to the second target device 25B through the third data output terminal D2 and the fourth data output terminal D3; the 5th and 6th bits from the lower bits of data 0×22 (i.e., 0×2, which is 10 in binary) are transmitted to the third target device 25C through the fifth data output terminal D4 and the sixth data output terminal D5; the 7th and 8th bits from the lower bits of data 0×22 (i.e., 0×0, which is 00 in binary) are transmitted to the fourth target device 25D through the seventh data output terminal D6 and the eighth data output terminal D7, but is not limited to.

In one of the embodiments, as shown in FIG. 4, at the rising edge of the second clock cycle, the serial peripheral interface transmission module 24 transmits the 1st and 2nd bits from the lower bits of data 0×94 (i.e., 0×0, which is 00 in binary) to the first target device 25A through the first data output terminal MOSI and the second data output terminal MISO; the 3rd and 4th bits from the lower bits of data 0×94 (i.e., 0×4, which is 01 in binary) are transmitted to the second target device 25B through the third data output terminal D2 and the fourth data output terminal D3; the 5th and 6th bits from the lower bits of data 0×94 (i.e., 0×1, which is 01 in binary) are transmitted to the third target device 25C through the fifth data output terminal D4 and the sixth data output terminal D5; the 7th and 8th bits from the lower bits of data 0×94 (i.e., 0×8, which is 10 in binary) are transmitted to the fourth target device 25D through the seventh data output terminal D6 and the eighth data output terminal D7, but is not limited to.

In one of the embodiments, as shown in FIG. 4, at the rising edge of the third clock cycle, the serial peripheral interface transmission module 24 transmits the 1st and 2nd bits from the lower bits of data 0×DD (i.e., 0×1, which is 01 in binary) to the first target device 25A through the first data output terminal MOSI and the second data output terminal MISO; the 3rd and 4th bits from the lower bits of data 0×DD (i.e., 0×C, which is 11 in binary) are transmitted to the second target device 25B through the third data output terminal D2 and the fourth data output terminal D3; the 5th and 6th bits from the lower bits of data 0×DD (i.e., 0×1, which is 01 in binary) are transmitted to the third target device 25C through the fifth data output terminal D4 and the sixth data output terminal D5; the 7th and 8th bits from the lower bits of data 0×DD (i.e., 0×C, which is 11 in binary) are transmitted to the fourth target device 25D through the seventh data output terminal D6 and the eighth data output terminal D7, but is not limited to.

In one of the embodiments, as shown in FIG. 4, at the rising edge of the fourth clock cycle, the serial peripheral interface transmission module 24 transmits the 1st and 2nd bits from the lower bits of data 0×50 (i.e., 0×0, which is 00 in binary) to the first target device 25A through the first data output terminal MOSI and the second data output terminal MISO; the 3rd and 4th bits from the lower bits of data 0×50 (i.e., 0×0, which is 00 in binary) are transmitted to the second target device 25B through the third data output terminal D2 and the fourth data output terminal D3; the 5th and 6th bits from the lower bits of data 0×50 (i.e., 0×1, which is 01 in binary) are transmitted to the third target device 25C through the fifth data output terminal D4 and the sixth data output terminal D5; the 7th and 8th bits from the lower bits of data 0×50 (i.e., 0×4, which is 01 in binary) are transmitted to the fourth target device 25D through the seventh data output terminal D6 and the eighth data output terminal D7, but is not limited to.

By analogy, in this way, the disclosure may synchronize and transmit data to four Dual Mode devices.

As mentioned above, in the embodiment of FIG. 4, the first target device 25A to the fourth target device 25D receive the reordered data from the byte reordering module 13, respectively. For example, the first target device 25A may receive data 2,0,1,0 sequentially, the second target device 25B may receive data 0,1,3,0 sequentially, the third target device 25C may receive data 2,1,1,1 sequentially, and the fourth target device 25D may receive data 0,2,3,1 sequentially, but is not limited to.

Through the above-mentioned data bit conversion, byte/bit reordering (optional), the data transmission device 200 in this disclosure can simultaneously transmit the data that has been specially arranged and assembled to multiple target devices in one data cycle, and the synchronous or interleaved data transmission has been implemented.

In addition, since the data is reassembled and sorted before transmission, its complexity increases and it is less likely to be cracked, so the data transmission device 200 in this disclosure is also suitable for applications that require high data security, such as data backup or distributed data storage. By decentralizing data to different devices, the performance and space utilization of the storage system can be improved.

To sum up, the data transmission device 200 in this disclosure solves the limitation that the conventional SPI can only communicate with a single device in the same data cycle through the data buffer 21, the data bit conversion module 22, the byte reordering module 23, the octal serial peripheral interface (SPI) transmission module 24 and the four target devices 25A-25D, and the synchronous or interleaved data transmission of multiple devices in Octal SPI mode has been implemented. At the same time, it improves the complexity, efficiency and security of data transmission, and can be applied to fields such as data backup, distributed data storage to enhance the performance and space of storage.

The above-described embodiments are merely illustrative of the principles, features, and effects of the present disclosure, and are not intended to limit the scope of implementation of the present disclosure. Any modifications and variations to the above embodiments made by those skilled in the art without departing from the spirit and scope of the present disclosure shall fall within the scope of the present invention. Accordingly, any equivalent modifications or alterations based on the contents disclosed herein shall be encompassed within the scope of the claimed invention. Therefore, the scope of legal protection of the present disclosure shall be defined by the claims.

What is claimed is:

1. A data transmission device for transmitting data to a plurality of target devices in Octal Mode, comprising:
a data buffer, configured to store at least one data;
at least one data bit conversion module, coupled to the data buffer and configured to receive the at least one data from the data buffer, and copy or reassemble a plurality of bits of the at least one data to generate at least one new data item;
a byte reordering module, coupled to the data bit conversion module and configured to receive the at least one new data item and perform a reordering on bit order or byte order of the at least one new data item and output at least one reordered data item; and
a serial peripheral interface transmission module, coupled to the byte reordering module and configured to transmit the at least one reordered data item to the plurality of target devices in Octal Mode after the reordering.

2. The data transmission device as claimed in claim 1, wherein the at least one data is one data item, the data bit conversion module copies the one data item to two data items that are identical, and respectively selects at least one lower bit of the two data items to assemble a first new data, and respectively selects at least one higher bit of the two data items that are identical to assemble a second new data.

3. The data transmission device as claimed in claim 1, wherein the at least one data is two data items or more, and the data bit conversion module respectively selects lower bits of the at least one data to assemble a first new data, and selects higher bits of the at least one data to assemble a second new data.

4. The data transmission device as claimed in claim 3, wherein the byte reordering module receives the first new data and the second new data from the data bit conversion module.

5. The data transmission device as claimed in claim 4, wherein the plurality of target devices are two Quad Mode devices, and the at least one reordered data item is segmented and transmitted to the two Quad Mode devices by the serial peripheral interface transmission module.

6. The data transmission device as claimed in claim 1, wherein the at least one data is one data item, and the data bit conversion module copies the one data item to four data items that are identical, and sequentially selects at least one bit from lower bits of the four data items to assemble a first new data to a fourth new data, respectively.

7. The data transmission device as claimed in claim 1, wherein the at least one data is four data items or more, and the data bit conversion module sequentially selects at least one bit from lower bits of the at least one data to assemble a first new data to a fourth new data, respectively.

8. The data transmission device as claimed in claim 7, wherein the plurality of target devices are four Dual Mode devices, the at least one reordered data item is segmented and transmitted to the four Dual Mode devices by the serial peripheral interface transmission module; and
the data bit conversion module selects 2-bit of the four data items to assemble the first new data to the four new data, respectively.

9. The data transmission device as claimed in claim 1, wherein when the data bit conversion module reassembles a plurality of bits of the at least one data, bits of the same positions in the at least one data are being selected for reassembly.

10. The data transmission device as claimed in claim 1, wherein the serial peripheral interface transmission module simultaneously transmits a plurality of data items to the plurality of target devices in a data cycle after the reordering.
